(19) United States
(12) Patent Application Publication
(10) Pub. No.: US 2012/0082542 A1
(43) Pub. Date: Apr. 5, 2012

(54) STEAM TURBINE ROTOR, METHOD OF MANUFACTURING THE SAME, AND STEAM TURBINE

(76) Inventor: Masato MISAWA, Yokohama-shi (JP)

(21) Appl. No.: 13/251,664

(22) Filed: Oct. 3, 2011

(30) Foreign Application Priority Data
Oct. 4, 2010 (JP) 2010-224909

(51) Int. Cl. F01D 5/06; F01D 9/02; B23P 15/00

(52) U.S. Cl. 415/208.1; 416/198 A; 29/889.2

(57) ABSTRACT

In one embodiment, a steam turbine rotor has a first and a second rotor, a first and a second flange, a bolt, and a cap nut. The first flange is connected to an end portion of a first shaft of the first rotor and has a first through hole. The second flange is connected to an end portion of a second shaft of the second rotor and has a second through hole. The bolt is inserted through the first and second through holes and has a shaft part, a male screw part disposed on one end of the shaft part, and a projection part disposed on an end portion of the male screw part. The cap nut has a female screw part engaged with the male screw part and a projection through hole which the projection part penetrates.

### CROSS-REFERENCE TO RELATED APPLICATION

This application is based upon and claims the benefit of priority from Japanese Patent Application No. 2010-224909, filed on Oct. 4, 2010; the entire contents of which are incorporated herein by reference.

### FIELD

Embodiments described herein relate generally to a steam turbine rotor, a method of manufacturing the same, and a steam turbine.

### BACKGROUND

Steam turbines in which a rotor for high-pressure steam turbine (high-pressure rotor) and a rotor for low-pressure steam turbine (low-pressure rotor) are coupled outside a turbine casing are known. Here, the high-pressure steam turbine and the low-pressure steam turbine are structured as follows. Specifically, the turbine casing is divided into a high-pressure turbine casing and a low-pressure turbine casing. In each of the high-pressure turbine casing and the low-pressure turbine casing, a turbine rotor having a turbine rotor blade and a turbine stator blade are housed.

When the high-pressure steam turbine and the low-pressure steam turbine are thus coupled outside the turbine casing, the steam turbine has a long span in its entirety. Accordingly, high/low-pressure integrated steam turbines are known, in which a high-pressure rotor and a low-pressure rotor are housed in one casing, thereby reducing the span.

Among such high/low-pressure integrated steam turbines, there is a type of steam turbine in which a high-pressure rotor and a low-pressure rotor are integrally coupled via a shaft coupling in a steam passage part. In a steam turbine of this type, the high-pressure rotor and the low-pressure rotor are produced separately using separate materials, and then are coupled with the shaft coupling. Accordingly, this type of steam turbine is of low manufacturing cost compared to integrated rotors for which the high-pressure rotor and the low-pressure rotor are produced integrally, welding rotors in which the high-pressure rotor and the low-pressure rotor are coupled by welding, and the like.

At this time, flanges of the shaft coupling are fastened with plural pairs of bolts and nuts, to thereby couple the high-pressure rotor and the low-pressure rotor. Upon fastening of the bolts and nuts, fastening margins between the bolts and the nuts are controlled, so as to securely couple the high-pressure rotor and the low-pressure rotor. That is, there are prevented insufficient fastening between the bolts and nuts leading to looseness between flange faces, and conversely excessive fastening between the bolts and nuts causing large tension to act on the bolts, leading to decrease in strength thereof.

Now, in this type of high/low-pressure integrated steam turbine, operating steam passing through a final turbine stage of the high-pressure turbine can become “wet steam”. As described above, the shaft coupling is disposed between the high-pressure rotor and the low-pressure rotor. Accordingly, when the operating steam passing through the final turbine stage of the high-pressure turbine becomes wet steam, the shaft coupling is exposed to a wet steam atmosphere.

In various occasions, the operating steam passing through the final turbine stage of the high-pressure turbine becomes wet steam. For example, the steam can become wet steam constantly depending on the design of the steam turbine. In other cases, it can become wet steam temporarily, such as when activation is stopped or during a partial load operation. There are also cases where dry steam, which is initially intended (when it is designed), becomes wet steam due to aging or the like through operating over years.

Regardless of the reason, when the shaft coupling is exposed to an atmosphere of wet steam, the possibility of corrosion of the shaft coupling increases. That is, when wet steam enters a gap between a bolt end portion of the shaft coupling and a hexagonal nut coupled thereto in which a screw hole is bored (namely, a gap between a male screw and a female screw), and corrosive components are deposited therebetween. When this state continues for a long time, the possibility of stress corrosion cracking of the bolt and the nut increases.

### BRIEF DESCRIPTION OF THE DRAWINGS

FIG. 1 is a half-cut vertical cross-sectional view conceptually illustrating a high/low-pressure integrated steam turbine according to one embodiment.

FIG. 2 is an enlarged cross-sectional view of a shaft coupling according to this embodiment.

FIG. 3 is a cross-sectional view illustrating, in enlargement, flanges used in the shaft coupling according to this embodiment.

FIG. 4 is an enlarged view of a stud bolt used in the shaft coupling according to this embodiment.

FIG. 5 is an enlarged cross-sectional view of cap nuts used in the shaft coupling according to this embodiment.

FIG. 6 is a flowchart representing manufacturing processes of the high/low-pressure integrated steam turbine according to this embodiment.

### DETAILED DESCRIPTION

In one embodiment, a steam turbine rotor has a first and a second rotor, a first and a second flange, a bolt, a cap nut, and a sealing part. The first rotor has a first shaft. The first flange is connected to an end portion of the first shaft and has a first through hole. The second rotor has a second shaft disposed on substantially a same axis as the first shaft. The second flange is connected to an end portion of the second shaft and has a second through hole corresponding to the first through hole. The bolt is inserted through the first and the second through hole and has a shaft part, a male screw part disposed on one end of the shaft part, and a projection part disposed on an end portion of the male screw part. The cap nut has a female screw part engaged with the male screw part and a projection through hole which the projection part penetrates. The sealing part seals a gap between the projection through hole and the projection part.

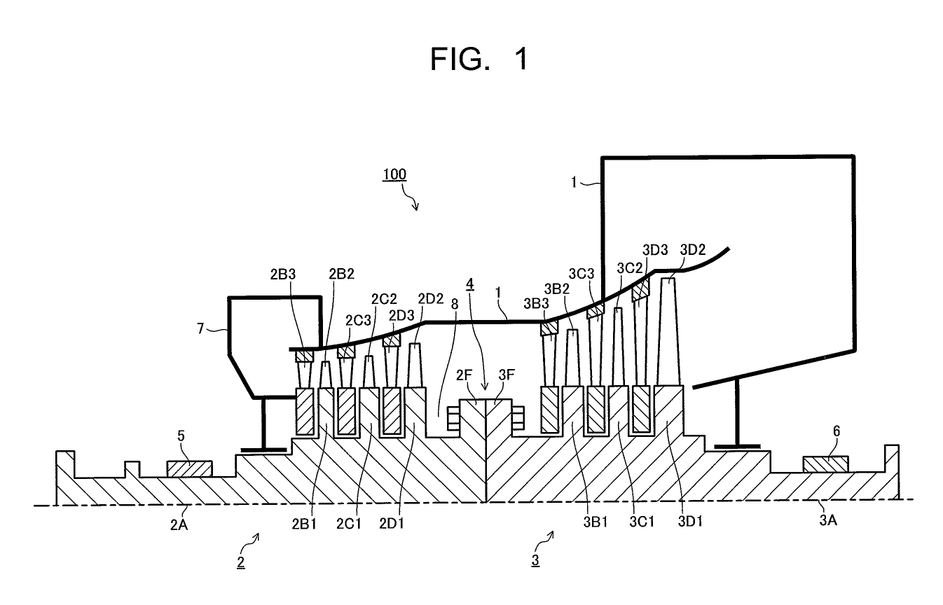

Hereinafter, with reference to the drawings, a steam turbine 10 having a high/low-pressure integrated rotor according to one embodiment will be described. FIG. 1 is a half-cut vertical cross-sectional view conceptually illustrating a high/low-pressure integrated steam turbine 100. The high/low-pressure integrated steam turbine 100 has a turbine casing 1, a high-pressure turbine rotor (hereinafter referred to as a high-pressure rotor) 2, a low-pressure turbine rotor (hereinafter referred to as a low-pressure rotor) 3, and a shaft coupling 4. In the turbine casing 1, a high-pressure turbine casing and a low-pressure turbine casing are formed integrally, and the high-pressure rotor 2 and the low-pressure rotor 3 are disposed therein. The high-pressure rotor 2 and the low-pressure rotor 3 are connected uniaxially by the shaft coupling 4.

The high-pressure rotor 2 is cut out from a block of steel material and has a shaft 2A and disks 2B1, 2C1, 2D1 which are formed integrally. The disks 231, 2C1, 2D1 are disposed along an axial direction of the shaft 2A. Turbine rotor blades 2B2, 2C2, 2D2 are attached to the disks 2B1, 2C1, 2D1, respectively.

The low-pressure rotor 3 is cut out from a block of steel material and has a shaft 3A and disks 3B1, 3C1, 3D1 which are formed integrally. The disks 3B1, 3C1, 3D1 are disposed along the axial direction of the shaft 3A. Turbine rotor blades 3B2, 3C2, 3D2 are attached to the disks 3B1, 3C1, 3D1, respectively.

Turbine stator blades 2B3, 2C3, 2D3 fixed to the casing 1 are disposed upstream of the disks 2B1, 2C1, 2D1 of the high-pressure rotor 2, respectively. A pair of the turbine stator blade 2B3 and the turbine rotor blade 2B2, a pair of the turbine stator blade 2C3 and the turbine rotor blade 2C2, and a pair of the turbine stator blade 2D3 and the turbine rotor blade 2D2 form a first to a third high-pressure turbine stage, respectively.

Similarly, turbine stator blades 3B3, 3C3, 3D3 fixed to the casing 1 are disposed upstream of the disks 3E1, 3C1, 3D1 of the low-pressure rotor 3, respectively. A pair of the turbine stator blade 3B3 and the turbine rotor blade 3B2, a pair of the turbine stator blade 3C3 and the turbine rotor blade 3C2, and a pair of the turbine stator blade 3D3 and the turbine rotor blade 3D2 form a first to a third low-pressure turbine stage, respectively.

Bearings 5, 6 are disposed on a high-pressure rotor side and a low-pressure rotor side, respectively, and fix the shafts 2A, 3A rotatably.

Note that since the high/low-pressure integrated steam turbine 100 illustrated in FIG. 1 is represented schematically, the respective turbine stages of the high/low-pressure steam turbine are three stages. In practice, it is usually the case that some more stages are provided.

To the high/low-pressure integrated steam turbine 100 structured as such, high-temperature, high-pressure operating steam is outputted from a not-illustrated boiler. After passing through not-illustrated steam valves (steam stop valve, steam adjust valve), this operating steam is delivered to a steam chamber 7 of the high-pressure turbine. The operating steam delivered to the steam chamber 7 performs expansion work in each of the first turbine stage (the turbine stator blade 2B3 and the turbine rotor blade 2B2), the second turbine stage (the turbine stator blade 2C3 and the turbine rotor blade 2C2), and the final turbine stage (the turbine stator blade 2D3 and the turbine rotor blade 2D2) of the high-pressure rotor 2, to thereby rotary drive the high-pressure rotor 2. Thereafter, the operating steam reaches a space part 8. This space part 8 is formed by the casing 1 and houses the shaft coupling 4. At this time, the operating steam which has passed through the final turbine stage of the high-pressure rotor 2 and reached the space part 8 decreases in temperature from about 250° C. to about 150° C. and becomes wet steam.

This operating steam which has become wet steam performs expansion work in each of the first turbine stage (the turbine stator blade 3B3 and the turbine rotor blade 3B2), the second turbine stage (the turbine stator blade 3C3 and the turbine rotor blade 3C2), and the final turbine stage (the turbine stator blade 3D3 and the turbine rotor blade 3D2) of the downstream low-pressure rotor 3, to thereby rotary drive the low-pressure rotor 3. Thereafter, the operating steam is exhausted to a not-illustrated steam condenser.

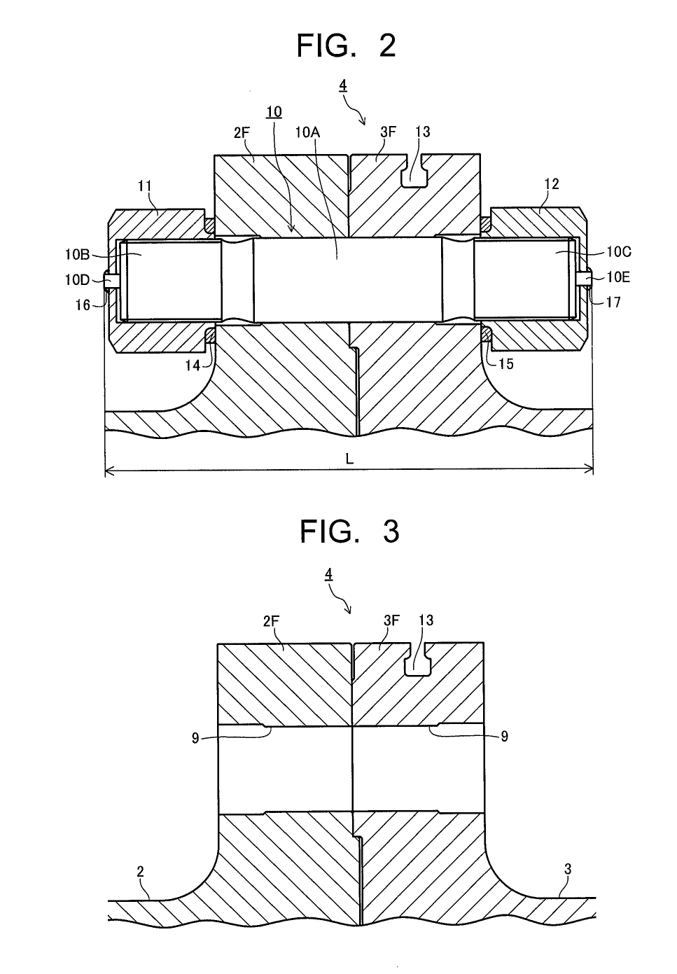

FIG. 2 illustrates the shaft coupling 4 coupling the high-pressure rotor 2 and the low-pressure rotor 3 of the steam turbine 100. The shaft coupling 4 is formed of flanges 2F, 3F, a stud bolt 10, and cap nuts 11, 12. FIG. 3 to FIG. 5 illustrate details of the flanges 2F, 3F, the stud bolt 10, and the cap nuts 11, 12.

As illustrated in FIG. 3, the flanges 2F and 3F having a circular plate shape are connected to respective end portions of the shafts 2A, 3A of the high-pressure rotor 2 and the low-pressure rotor 3. The shafts 2A, 3A are disposed together on substantially the same axis. The flanges 2F and 3F have principal surfaces (abutting faces, end faces) touching or opposing each other. The flanges 2F and 3F each have a plurality of (normally about 20 depending on the diameter of the shaft) bolt through holes 9 along a circumferential direction thereof. The bolt through holes 9 of the flanges 2F and 3F are disposed corresponding to each other. The stud bolt 10 is inserted through each of the bolt through holes 9, and the cap nuts 11, 12 are screwed with male screw parts 10B, 10C of both sides of the bolt.

Here, a trench 13 is an annular trench formed in an outer periphery of the flange 3F on the low-pressure rotor 3 side. A not-illustrated balance weight is attached to this trench 13, thereby balancing the rotation thereof. This trench 13 may be provided on the flange 2F on the high-pressure rotor 2 side.

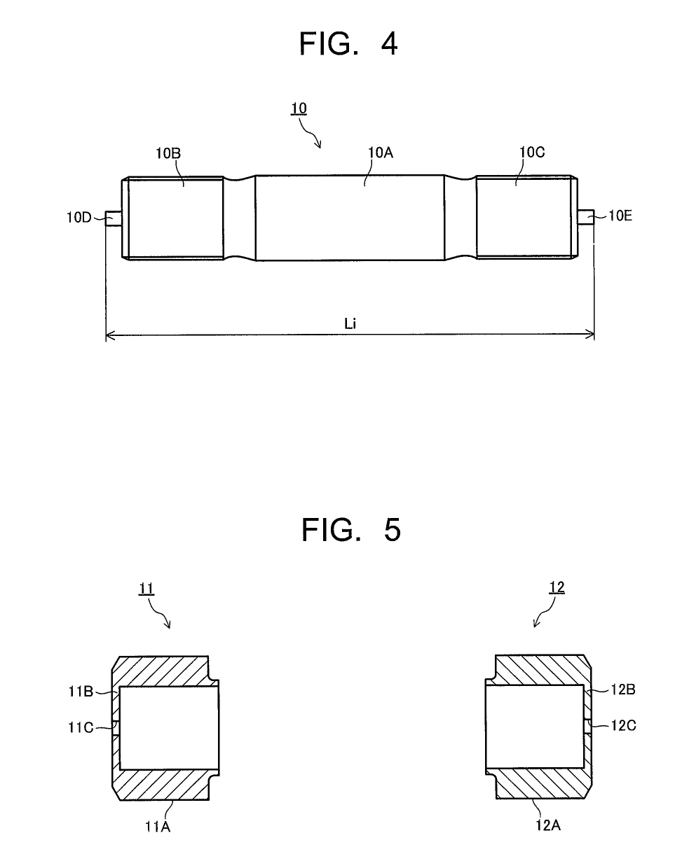

As illustrated in FIG. 4, the stud bolt 10 has an intermediate part (shaft part) 10A, male screw parts 10B, 10C, and projections 10D, 10E. The male screw parts 10B, 10C are disposed on both sides of the intermediate part 10A. Male screws are formed in an outer periphery of the male screw parts 10B, 10C. The projections 10D, 10E are disposed on most distal ends on a center line (the axial direction) of the male screw parts 10B, 10C.

A cross-sectional shape perpendicular to a center line of the projections 10D, 10E can be set appropriately to a circle or a polygon. However, the largest width in a radial direction of the projections 10D, 10E is set smaller than diameters of the intermediate part 10A and the male screw parts 10B, 10C.

The length from a distal end of the one projection 10D on one side to a distal end of the projection 10E on the opposite side of the stud bolt 10 (axial length) is aligned with a length Li which is prescribed in advance at the time of producing the stud bolt 10. That is, in a state that no tensile force or compressive force is applied to the stud bolt 10, the length is controlled to be Li.

As illustrated in FIG. 5, the cap nuts 11 and 12 have female screw parts 11A, 12A, closing parts 11B, 12B, and projection through holes 11C, 12C, respectively. The female screw parts 11A, 12A have a substantially cylindrical shape and have a female screw in an inner periphery (screw hole) thereof. The female screws of the female screw parts 11A, 12A are mated (screwed) with male screws of the male screw parts 10B, 10C of the stud bolt 10. The closing parts 11B, 12B have a substantially disc shape and close one ends of screw holes of the female screw parts 11A, 12A. The closing parts 11B, 12B have the projection through holes 11C, 12C for allowing penetration of the projections 10D, 10E.

In FIG. 2, washers 14 and 15 are interposed between the flange 2F and the cap nut 11 and between the flange 3F and the cap nut 12, respectively.

### (Assembling the Shaft Coupling 4)

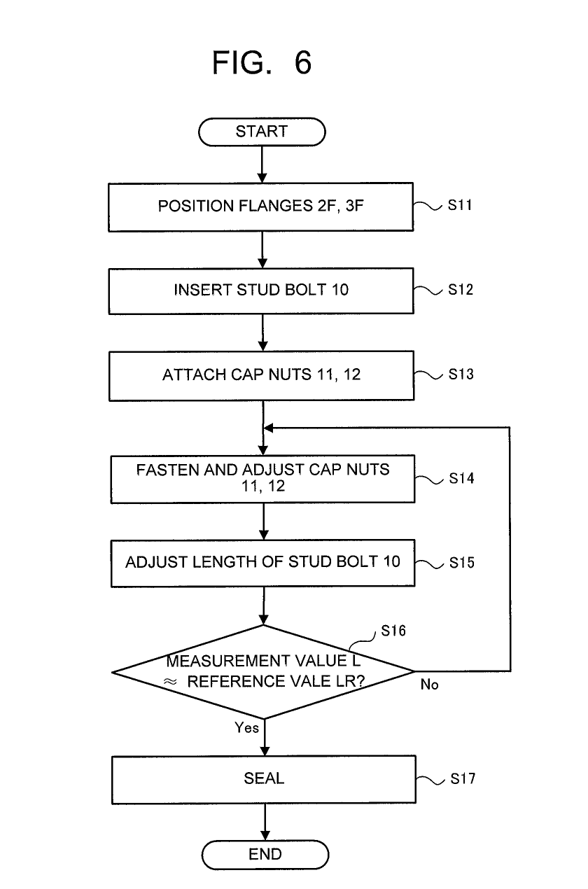

Next, assembling processes of the shaft coupling 4 in this embodiment will be described. FIG. 6 is a flowchart representing assembling processes of the shaft coupling 4 (manufacturing processes of the steam turbine rotor) in this embodiment.

### (1) Aligning the Flanges 2F, 3F (Step S11)

First, the bolt through holes 9 of the flanges 2F, 3F of the high/low-pressure rotors 2, 3 are positioned. For example, the positioning is performed by fitting male and female fitting parts formed in the abutting faces (end faces) of the flanges 2F, 3F.

### (2) Inserting the Stud Bolt 10 in the Bolt Through Holes 9 (Step S12)

Once the flanges 2F, 3F are positioned, the stud bolt 10 is inserted in the bolt through holes 9.

### (3) Attaching and Fastening the Cap Nuts 11, 12 on the Stud Bolt 10 (Steps S13, S14)

The washers 14, 15 are fitted with the male screw parts 10B, 10C on both ends of the stud bolt 10. Thereafter, the cap nuts 11, 12 are screwed (fastened) with the stud bolt 10 almost evenly using an appropriate tool.

### (4) Measuring the Length L of the Stud Bolt 10 (Step S15)

As illustrated in FIG. 2, the screwing is continued until the projections 10D, 10E of the stud bolt 10 project from the principal surfaces of the closing parts 11B, 12B of the cap nuts 11, 12 (end faces of the cap nuts 11, 12) by an appropriate length, respectively. Thereafter, a length L between the end portions (distal ends) of the projections 10D, 10E (the length L of the stud bolt 10) is measured. At this point, tensile force operates on the stud bolt 10 from both sides. Accordingly, the measurement value L extends longer in some measure than the length Li in an initial state, that is, a state that no tensile force or compressive force is applied (L>Li).

### (5) Comparing the Measurement Length L and Reference Length LR (Step S16).

It is judged whether the measurement length L at this point has reached a predetermined length (reference length) LR set in advance. When this judgment is “No” (LR>L>Li), the cap nuts 11, 12 are screwed more (step S14). Then, the length L between the end portions of the projections 10D, 10E are measured again (step S15).

These screwing and measuring processes are repeated for an appropriate number of times. When the measurement length L substantially matches the reference length LR (L≈LR) (step S16), the screwing of the cap nuts 11, 12 is stopped, and their positions are retained.

Note that when the measurement length L is larger than the reference length LR, the fastening of the cap nuts 11, 12 is loosened (steps S16, S14).

Let us assume that the measurement length L substantially matches the reference length LR. At this point, the length LR between the end portions of the projections 10D, 10E of the stud bolt 10 is extended by a length δ from the length (initial value) Li of the unused bolt (δ=LR−Li). The length δ of the amount of extension of the stud bolt 10 is called “bolt fastening margin”.

This bolt fastening margin 8 is a length depending on the tensile force of the stud bolt 10. Accordingly, when it is possible to confirm by measurement that the length of the stud bolt 10 has become LR, it is possible to confirm that the fastening force by the stud bolt 10 and the cap nuts 11, 12 of the shaft coupling 4 corresponds to a predetermined value. That is, this means that the stud bolt 10 and the cap nuts 11, 12 of the shaft coupling 4 are fastened neither excessively nor insufficiently.

### (6) Sealing Between the Projections 10D, 10E of the Stud Bolt 10 and the Projection Through Holes 11C, 12C (Step S17)

In this manner, the fastening force by the stud bolt 10 and the cap nuts 11, 12 of the shaft coupling 4 (that is, the bolt fastening margin being a predetermined value) is confirmed. At this point, gaps between the projections 10D, 10E of the stud bolt 10 and the projection through holes 11C, 12C of the cap nuts 11, 12 are sealed (tightly sealed). For example, they are welded with a welding material. Seal parts (sealants) 16, 17 in FIG. 2 are the portions sealed by welding. By this welding, not only a seal (sealing) but also anti-loosening of the cap nuts 11, 12 can be expected.

Note that it is not necessary to limit the seal parts 16, 17 between the projections 10D, 10E of the stud bolt 10 and the projection through holes 11C, 12C of the cap nuts 11, 12 to welding. For example, it is possible to employ a caulking material (sealing material), which is resistant to temperatures of wet steam (for example, steam at a temperature of about 250° C.) to which the shaft coupling 4 is exposed and has components which do not corrode the rotor material.

Thus, in this embodiment, the projections 10D, 10E are provided on the stud bolt 10, and the projection through holes 11C, 12C are provided on the cap nuts 11, 12. Consequently, the fastening margin of the stud bolt 10 and the cap nuts 11, 12 can be controlled securely. After the fastening margin is controlled and the stud bolt 10 and the cap nuts 11, 12 are fastened in this manner, gaps between the projections 10D, 10E of the stud bolt 10 and the projection through holes 11C, 12C of the cap nuts 11, 12 are closed. Further, gaps between the flanges 2F, 3F and the cap nuts 11, 12 are closed (sealed) by the washers 14, 15. Accordingly, wet steam as operating steam of the low-pressure rotor 3 would not enter screw coupling parts by the stud bolt 10 and the cap nuts 11, 12 (stress concentration parts by the screw coupling) as well as the bolt through holes 9 of the flanges 2F, 3F. Therefore, corrosive components (for example, moisture (water) and dissolved ions therein) contained in the wet steam would not be deposited on these parts, and it is not necessary to concern about stress corrosion cracking.

In the above-described embodiments, the lengths LR between the end portions of the projections 10D, 10E of the stud bolt 10 is measured to confirm whether the fastening margin of the stud bolt 10 corresponds to a predetermined value or not Instead of this, lengths of the end portions of the projections 10D, 10E projecting from the end faces of the cap nuts 11, 12 may be measured. The length of the stud bolt 10 is measured indirectly, and whether the fastening margin of the stud bolt 10 corresponds to a predetermined value can be confirmed. In this case, it is necessary to control thickness dimensions of the cap nuts 11, 12 and the washers 14, 15 to prescribed values in advance.

In the above-described embodiments, two cap nuts 11, 12 are connected to the stud bolt 10. In this point, only one cap nut may be connected to the stud bolt 1. In this case, the stud bolt has a shaft part, a male screw part, a projection part, and a head part. That is, instead of the male screw part 10C and the projection part 10E of the stud bolt 10, the head part is disposed on one end (right end in FIG. 4) of the intermediate part 10A (shaft part). The head part is, for example, a substantially columnar shape having a diameter larger than the diameter of the bolt through hole 9.

In this case, sealing with the seal part 17 is unnecessary. Further, the length of the stud bolt can be prescribed as the length between a front end of the projection part and an end face of the head part.

As described above, according to this embodiment, in the high/low-pressure integrated steam turbine in which the high-pressure rotor and the low-pressure rotor are coupled uniaxially with the shaft coupling, gaps are sealed between the bolts and the nuts of the shaft coupling between rotors. Accordingly, even when the shaft coupling is exposed to wet steam, corrosion between the bolts and the nuts can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A steam turbine rotor, comprising:
a first rotor comprising a first shaft;
a first flange connected to an end portion of the first shaft and comprising a first through hole;
a second rotor comprising a second shaft disposed on substantially a same axis as the first shaft;
a second flange connected to an end portion of the second shaft and comprising a second through hole corresponding to the first through hole;
a bolt inserted through the first and the second through hole, and comprising a shaft part, a male screw part disposed on one end of the shaft part, and a projection part disposed on an end portion of the male screw part;
a cap nut comprising a female screw part engaged with the male screw part and a projection through hole which the projection part penetrates; and
a sealing part sealing a gap between the projection through hole and the projection part.

2. The steam turbine rotor according to claim 1,
wherein the bolt comprises a second male screw part disposed on another end of the shaft part, and a second projection part disposed on an end portion of the second male screw part, and
the steam turbine rotor further comprising:
a second cap nut comprising a second female screw part engaged with the second male screw part and a second project ion through hole which the second projection part penetrates; and
a second sealing part sealing a gap between the second projection through hole and the second projection part.

3. The steam turbine rotor according to claim 1,
wherein the bolt comprises a head part disposed on another end of the shaft part.

4. The steam turbine rotor according to claim 1,
wherein the sealing part is formed by welding.

5. The steam turbine rotor according to claim 1,
wherein a component material of the sealing part comprises a heatproof temperature of 250° C. or higher, and does not corrode component materials of the first and the second rotor.

6. A method of manufacturing a steam turbine rotor, the method comprising:
preparing a first rotor comprising a first shaft and a first flange connected to an end portion of the first shaft and comprising a first through hole; and
a second rotor comprising a second shaft and a second flange connected to an end portion of the second shaft and comprising a second through hole;
disposing the first and the second rotor so that the first and the second flange face or contact each other and the first and the second through hole correspond to each other;
inserting through the first and the second through hole a bolt comprising a shaft part, a male screw part disposed on one end of the shaft part, and a projection part disposed on an end portion of the male screw part;
engaging with the male screw part a female screw part of a cap nut comprising the female screw part and a projection through hole, and inserting the projection part through the projection through hole;
measuring the length of the bolt; and
sealing a gap between the projection through hole and the projection part when the measured length corresponds to a reference value.

7. The method according to claim 6,
wherein the bolt comprises a second male screw part disposed on another end of the shaft part, and a second projection part disposed on an end portion of the second male screw part, and
the method further comprising:
engaging with the second male screw part a second female screw part of a second cap nut comprising the second female screw part and a second projection through hole; and
inserting the second projection part through the second projection through hole.

8. The method according to claim 7,
wherein the step of measuring comprises measuring a length between a front end of the projection part and a front end of the second projection part.

9. The method according to claim 7, further comprising
sealing a gap between the second projection through hole and the second projection part when the measured length corresponds to a reference value.

10. The method according to claim 6,
wherein the bolt comprises a head part disposed on another end of the shaft part.

11. The method according to claim 6,
wherein the step of measuring comprises measuring a length between an end face of the cap nut and a front end of the projection part.

12. A steam turbine, comprising:
the steam turbine rotor according to claim 1;
a casing housing the steam turbine rotor; and
a stator blade engaging with the steam turbine rotor.
